(19) United States
(12) Patent Application Publication
(10) Pub. No.: US 2014/0292804 A1
(43) Pub. Date: Oct. 2, 2014

(54) Package for Consumer Product

(71) Applicant: THE IAMS COMPANY, Cincinnati, OH (US)

(72) Inventors: Luisa Valerio Gonzalez, Cincinnati, OH (US); Giles Michael Owen Hopley, Madeira, OH (US)

(73) Assignee: The Iams Company, Cincinnati, OH (US)

(21) Appl. No.: 13/851,982

(22) Filed: Mar. 28, 2013

(51) Int. Cl. G06T 13/80; G09G 5/377

(52) U.S. Cl. CPC G06T 13/80; G09G 5/377
USPC 345/629

(57) ABSTRACT

A printed article includes a perspective image of a scenic background, and a perspective image of animate object. The object is portrayed in motion. The scenic background image has a first perspective axis, and a first image illumination source location. The animate object image has a second perspective axis and a second image illumination location. The second perspective axis is dissimilar to the first perspective axis. The second image illumination location is dissimilar to the first image illumination location. The images of the scenic background and the animated object are combined in a composite image of the animated object set to appear in front of the scenic background.

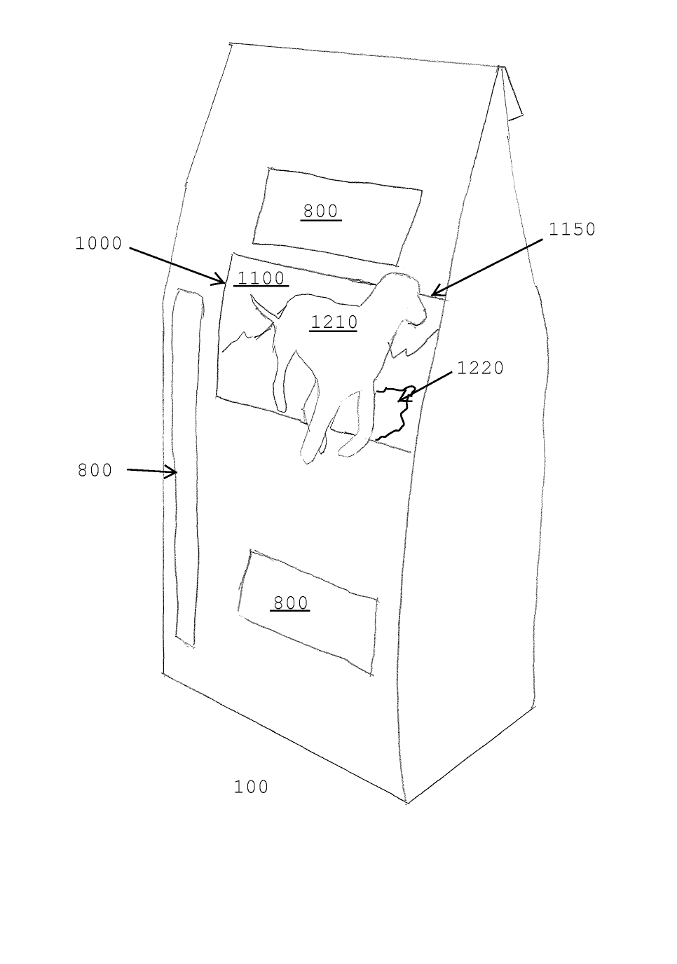

### FIELD OF THE INVENTION

The invention relates to the field of packaging for consumer products. The invention relates particularly to the field of consumer product packaging visual decoration and appearance.

### BACKGROUND OF THE INVENTION

Decorative consumer products packages are well known in the art. The challenges confronting the manufacturers and marketers of consumer products in both brick and mortar and on-line retail environments include attracting the attention of potential buyers sufficiently to engage the shopper and proceed to a sale.

In many environments, decorative artwork is disposed upon the product packages to attract the attention of the shopper. As many products utilize some form of decorative appearance the challenge escalates to one of having artwork and associated packages stand out in an ever more decorative environment.

What is needed is a package artwork strategy and execution which yields a distinctive appearance and successfully attracts the attention f the shopper.

### SUMMARY OF THE INVENTION

In one aspect, a printed article includes a perspective image of a scenic background, and a perspective image of animate object. The animate object is portrayed in motion. The scenic background image has a first perspective axis, and a first image illumination source location. The animate object image has a second perspective axis and a second image illumination location. The second perspective axis is dissimilar to the first perspective axis. The second image illumination location is dissimilar to the first image illumination location. The images of the scenic background and the animated object are combined in a composite image of the animated object set to appear in front of the scenic background.

### BRIEF DESCRIPTION OF THE DRAWINGS

The FIGURE provides a schematic perspective illustration of a package according to one embodiment of the invention.

### DETAILED DESCRIPTION OF THE INVENTION

All efforts in this description to provide examples of referenced element or items are considered to be representative only and are in no way intended as limiting the scope of the claimed invention.

As used herein, consumer products packaging refers to the primary, secondary, tertiary, etc., packages used for the purposes of containing and conveying consumer products to market. Consumer products are considered to be products for acquisition/purchase and/or consumption by the purchaser, as contrasted to products purchased for re-sale or products purchased as part of a manufacturing supply chain as components in a subsequent product. Consumer products include consumable, perishable, semi-durable and durable goods.

Products packaging includes materials such as paper of varying grades from tissue papare trough corrugated stock, polymeric films, metal films, wood, glass, ceramics, as well as composite materials and combinations of these materials.

Packaging materials may be decorated using processes known in the art such as flexographic, gravure printing, direct ink-jet printing and other decoration processes.

As illustrated in the Figure. A consumer product package, 100, comprises a composite image 1000. The composite image 1000 comprises a background image 1100, and a foreground image.

The background image 1100, comprises a scenic background, contrasted to a solid color background or stylized background of curves and/or simple geometric shapes. The background image defines at least one edge, 1150, which is not coextensive with an edge of the package 100. At least a portion of the foreground image extends beyond the defined edge 1150, of the background image 1100. The package 100 may further comprise indicia 800 associated with conveying product branding and associated marketing information.

The scenic background may compromise an interior or exterior scene. Examples include a country meadow with a distant tree-line, a park setting with a distant skyline and/or foliage, and interior setting with furniture and/or walls in the distance. The scenic background image is depicted having a first image axis of perspective defined as the angle of perspective of the image. The scenic background image may further be defined in terms of the location of the illumination source of the image relative to the objects portrayed in the image. The illumination source may further be defined in terms of the visible spectrum and relative intensities of the respective components of the spectrum which comprise the output of the source. The scenic background image may be portrayed having a first level of focus.

The foreground image, comprises an animate object 1210. Exemplary animate object include dogs, cats, human beings, horses, birds, and combination of these. The foreground image portrays the animate object 1210 in a state of motion contrasted with an image of the object clearly at rest. As an example, a dog may be captured or portrayed as running or walking and captured in mid-stride.

The foreground image has a second axis of perspective which is dissimilar to that of the scenic background image. The foreground image has a second illumination source location which is also dissimilar to the illumination source location of the scenic background image. The foreground image has a degree of image focus which is dissimilar to and sharper than that of the background image. The foreground image further comprise a shadow (not shown) associated with the animate object. The associated shadow may be unrelated to any actual shadow created by the illumination of the animate object 1210 by the second illumination source. The shadow may have a degree of focus which differs from and is less than that of the animate object 1210. The respective image elements, the scenic background 1100, and animate object 1210, and shadow 1220, may ach be captured using digital cameras. The Canon 1Dx and 5D Mark III digital cameras, available from Canon, USA, Inc., of Melville, N.Y., are exemplary digital cameras for capturing the elements. As an example, with respect to a x-y-z coordinate system with an origin at (0,0,0), the illumination source for the background image may be disposed at a first location designated (x1, y1, z1), the illumination source for the foreground disposed at (x2, y2, z2), the camera for the background image disposed at (x3, y3, z3) and the camera for the foreground image disposed at (x4, y4, z4). In this example the foreground object may be disposed at (x5, y5, z5) and a reference point associated with the background image disposed at (x6, y6, z6) setting out the respective locations of the elements of the composite image.

In one embodiment, the animate object in the foreground image may be associated with the product contained within the package. An animal may be portrayed upon a package containing food or other products intended for the type of animal portrayed.

One or more of the elements may be created rather than captured using a camera. Computer software, such as Illustrator, from Adobe Systems, Inc, of San Jose, Calif., may be used to create virtual scenes, objects, and shadow elements as desired. Illustrator, or other software, may further be used to combine virtual and actual images into the final composite artwork intended for the package. The composite image may portray the animate object in motion and extending beyond the frame created by the edge of the scenic background upon the article.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A printed article comprising:
a. A perspective image of a scenic background, the scenic background image having a first perspective axis, and a first image illumination source location;
b. a perspective image of animate object, the object portrayed in motion, the animate object image having a second perspective axis, the second perspective axis being dissimilar to the first perspective axis, the animate object image having a second image illumination source dissimilar to the first image illumination source;
wherein the images of the scenic background and the animated object are combined in a composite image of the animated object set to appear in front of the scenic background.

2. The printed article according to claim 1, wherein the angular offset between the first axis of perspective and second axis of perspective is about DDD degrees.

3. The printed article according to claim 1, wherein the article comprises a consumer product package.

4. The printed article according to claim 3, wherein the animate object is associated with the consumer product.

5. The printed article according to claim 1 wherein the article comprises a consumer product.
